(19) United States
(12) Patent Application Publication
(10) Pub. No.: US 2011/0035921 A1
(43) Pub. Date: Feb. 17, 2011

(54) QUICK RELEASE DEVICE AND METHOD OF SECURING AND RELEASING AN OBJECT

(76) Inventor: WADE SPOONER, Opelika, AL (US)

Correspondence Address: WADE SPOONER, 3208 NORTHGATE DRIVE, OPELIKA, AL, 36801, US

(21) Appl. No.: 12/539,726

(22) Filed: Aug. 12, 2009

(51) Int. Cl. B23P 19/00; A45F 5/00

(52) U.S. Cl. 29/426.1; 224/271

(57) ABSTRACT

A device and method of securing and releasing an object is disclosed. The device includes a butterfly anchor having a first retractable arm and a second retractable arm, and having a nut in a middle portion of the butterfly anchor, the nut having a first nut end and a second nut end, wherein each retractable arm of the butterfly anchor is coupled to each end of the nut. A spring surrounds one of the nuts and has spring arms engaged along a portion of each retractable arm to spread them apart. A rod is threaded at one end in the nut. An object is coupled around the periphery of the rod, wherein the object rests against an upper peripheral edge of the butterfly anchor. Pressure is applied to the retractable arms to release the object from the device or place the object on the device.

### FIELD OF THE INVENTION

This invention relates to a device for securing and releasing an object. More particularly, the invention relates to a quick release device for securing and releasing an object, wherein the device includes a butterfly anchor with retractable arms, a spring, and a nut and a rod threaded at one end in the nut, and wherein pressure is applied to the retractable arms to release the object from the device or to place an object on the device.

### BACKGROUND OF THE INVENTION

Many devices support particular objects from the human body or an item of clothing. Pack systems and belts have been used to carry or transport objects of various sizes and purposes. Tool bags and/or belt-supported pouches for carrying nails, screws, bolts and other tools are well known in the industry. Lanyards for belts upon which one can attach various articles, such as keys, tools and other objects are well known in the art.

None of these conventional systems allow for the easy placement and quick removal of objects. Plus, many objects are not well suited to being suspended on (or coupled to) these systems and attempts to access objects from these conventional systems can be dangerous. What is needed is a quick release device for securing and releasing an object that provides easy access and can be worn on various parts of the body or attached to other devices.

### SUMMARY OF THE INVENTION

The present invention is directed to a device and method of securing and releasing an object. In one embodiment, the device comprises a butterfly anchor having a first retractable arm and a second retractable arm, and having a nut in a middle portion of the butterfly anchor, the nut having a first nut end and a second nut end, wherein each retractable arm of the butterfly anchor is coupled to each end of the nut. The device also comprises a spring surrounding one of the nut ends and having spring arms engaged along a portion of each retractable arm to spread them apart. The device further comprises a rod threaded at one end in the nut.

In accordance with one embodiment of the present invention, the object is coupled around the periphery of the rod and resting against an upper peripheral edge of the butterfly anchor. The rod can be coupled to a chain and the chain coupled to a tool belt. Alternatively, the chain can be coupled to an item of clothing. The object is at least one of tape, electrical tape, work tools, and toilet paper rolls, and can be any object that is on a roll, with an open center, or any object that is rounded. The nut can be a flanged nut, press-in nut, standard, and weld-on nut. The threaded rod comprises one of a screw, a bolt, a screw rod, and a shaft. In one embodiment, the device and/or the rod can be coupled to a chain, a zip chain, an item of clothing, and a tool belt.

In accordance with another embodiment of the present invention, a method of securing and releasing an object is disclosed. The method comprises providing a butterfly anchor having a first retractable arm and a second retractable arm; providing a nut in a middle portion of the butterfly anchor, the nut having a first nut end and a second nut end; coupling each retractable arm of the butterfly anchor to each end of the nut; surrounding one of the nut ends with a spring; engaging spring arms of the spring along a portion of each retractable arm to spread them apart; and threading one end of a rod in the nut.

In accordance with one embodiment of the present invention, the method further comprises coupling an object around the periphery of the rod, wherein the object rests against an upper peripheral edge of the butterfly anchor. The method can further comprise applying pressure to the retractable arms to release the object from the device or to place the object on the device. The method can also comprise coupling the rod to a chain and coupling the chain to a tool belt. Alternatively, the method comprises coupling the chain to an item of clothing. The method can also comprises coupling the device and/or the rod to one of a chain, a zip chain, an item of clothing, and a tool belt.

### BRIEF DESCRIPTION OF THE DRAWINGS

FIG. 1 shows a side view of a device for securing and releasing an object, in accordance with one embodiment of the present invention.

FIG. 2 shows a bottom view of a device for securing and releasing an object, in accordance with one embodiment of the present invention.

FIG. 3 shows a perspective view of a device for securing and releasing an object, with the object placed on the device, in accordance with one embodiment of the present invention.

FIG. 4A shows a side view of a device for securing and releasing an object, with the object being released from the device upon the application of pressure, in accordance with one embodiment of the present invention.

FIG. 4B shows a side view of a device for securing and releasing an object, with the object placed on the device upon the application of pressure, in accordance with one embodiment of the present invention.

### DETAILED DESCRIPTION OF THE PREFERRED EMBODIMENTS

The present invention is directed to a device and method of securing and releasing an object. The present invention affords easy access to objects, including tools and other items, and can be worn on various parts of the body or attached to other devices. The present invention also allows for the easy placement and quick release of objects.

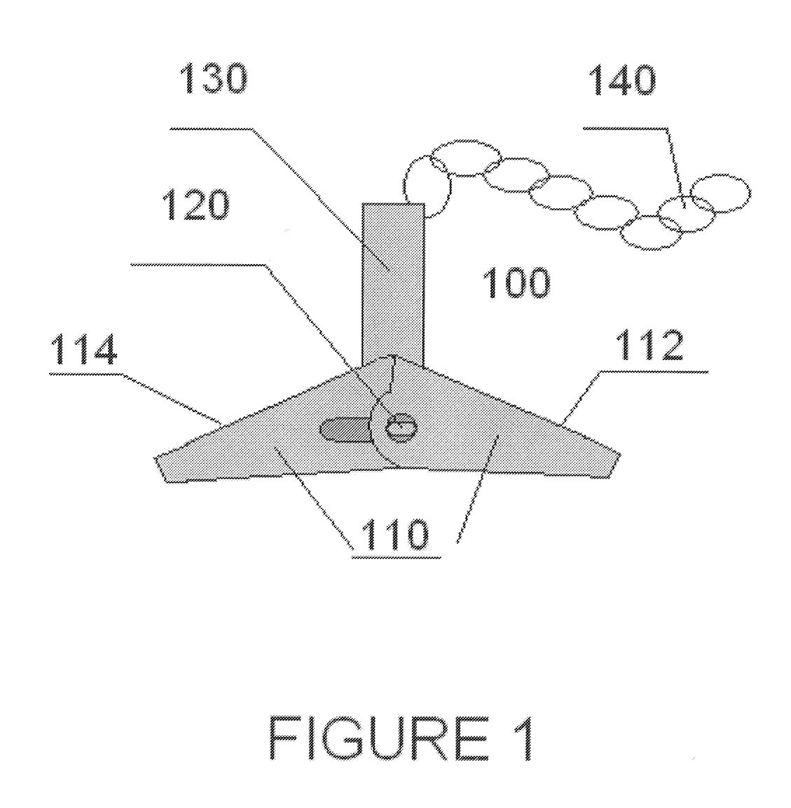

FIG. 1 shows a side view of a device 100 for securing and releasing an object, in accordance with one embodiment of the present invention. The device 100 includes a butterfly anchor 110 having a first retractable arm 112 and a second retractable arm 114. The device 100 also includes a nut 120 in a middle portion of the butterfly anchor 110. The device 100 further includes a rod 130 threaded at one end in the nut 120. In this embodiment, the rod 130 is coupled to a chain 140. In other embodiments, the rod 130 can be coupled to an item of clothing, a tool belt, a zip chain, or other similar devices. The chain 140 can be coupled to a tool belt (not shown) or an item of clothing (not shown).

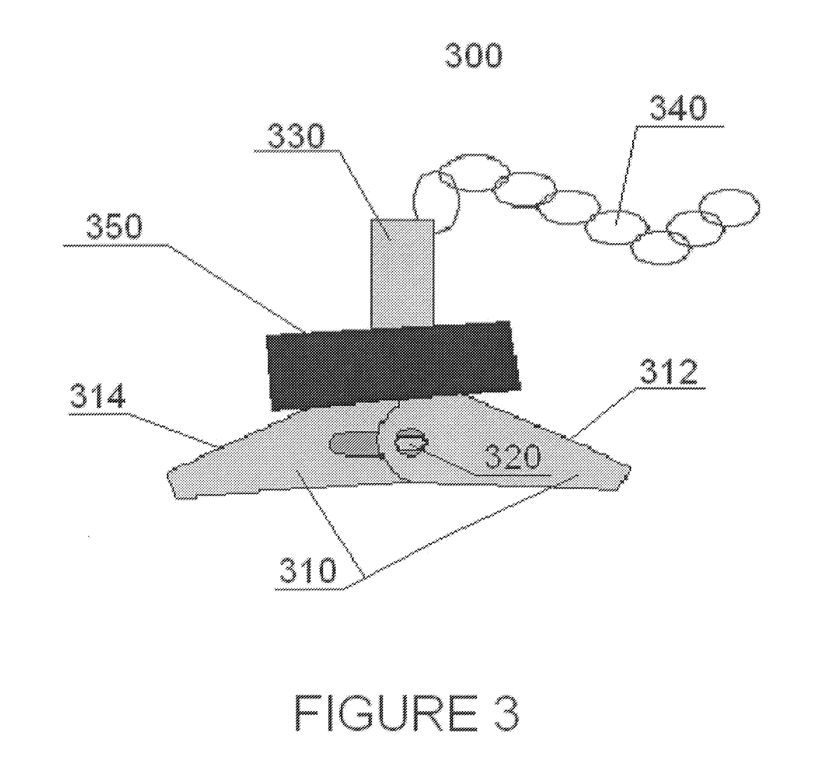

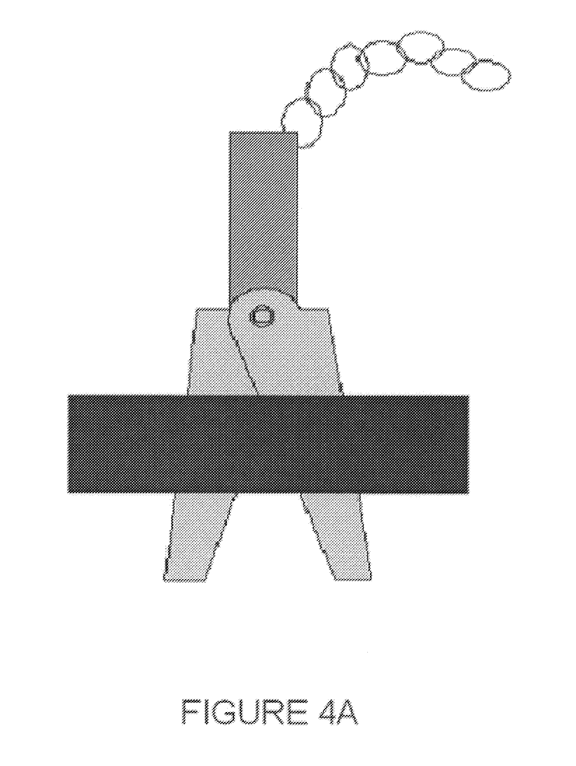

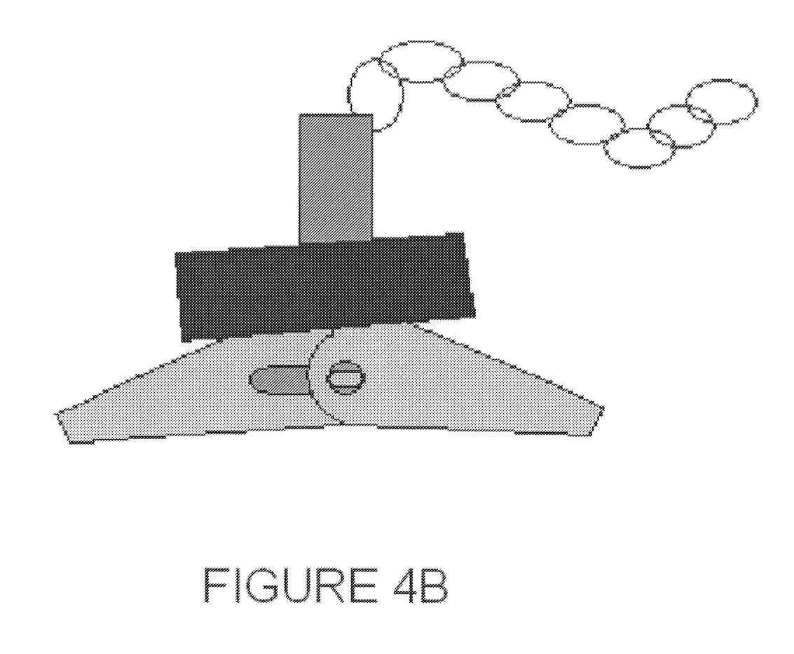

The object can be tape, electrical tape, work tools, and toilet paper rolls. In addition, the object can be any item that is on a roll, with an open center or round shape. The object is coupled around the periphery of the rod 130 and resting against an upper peripheral edge of the butterfly anchor 110, as shown in FIG. 3 and FIG. 4B. The nut 120 is one of a flanged nut, press-in nut, standard nut, and weld-on nut. The rod 130, which is threaded, is one of a screw, a bolt, a screw rod, and a shaft.

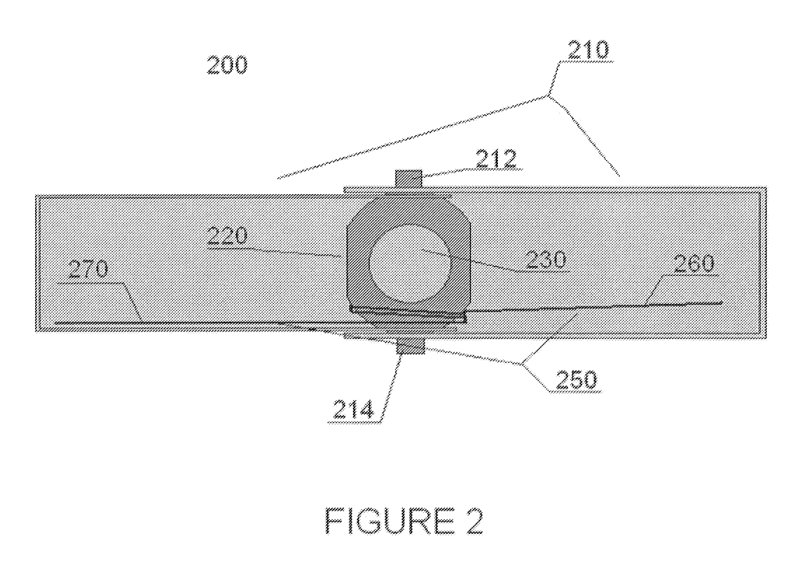

FIG. 2 shows a bottom view of a device 200 for securing and releasing an object, in accordance with one embodiment of the present invention. The device 200 includes a butterfly anchor 210 having a first retractable arm and a second retractable arm. The device also includes a nut 220 in a middle portion of the butterfly anchor 210. The nut 220 has a first nut end 212 and a second nut end 214. Each retractable arm of the butterfly anchor 210 is coupled to each end 212 and 214 of the nut 220. The device 200 further includes a spring 250 surrounding one of the nut ends and having spring arms 260 and 270 engaged along a portion of each retractable arm of the butterfly anchor 210 to spread them apart. In the FIG. 2, the spring 250 surrounds the second nut end 214. The device 200 further includes a rod 230 threaded at one end in the nut 220.

FIG. 3 shows a perspective view of a device 300 for securing and releasing an object, with the object placed on the device 300, in accordance with one embodiment of the present invention. The device 300 includes a butterfly anchor 310 having a first retractable arm 312 and a second retractable arm 314 and a nut 320 in a middle portion of the butterfly anchor 310. The nut 320 has a first nut end and a second nut end and each retractable arm of the butterfly anchor 310 is coupled to each end of the nut 320. A spring, as shown in the FIG. 2, surrounds one of the nut ends and has spring arms engaged along a portion of each retractable arm to spread them apart. The device 300 also includes a rod 330 threaded at one end in the nut 320. In this embodiment, the rod 330 is coupled to a chain 340. Alternatively, instead of being coupled to a chain, the rod 330 can be coupled to an item of clothing (not shown), a tool belt (not shown) or another device.

Still referring to FIG. 3, the object is coupled around the periphery of the rod 330 and rests against an upper peripheral edge of the butterfly anchor 310. When pressure is applied to the retractable arms 312 and 314 of the butterfly anchor 310 the object is released from the device 300. Pressure can be applied by condensing or squeezing the retractable arms 312 and 314 with one or two hands. Conversely, the object can be placed back on the device 300 by first applying pressure to the retractable arms 312 and 314, positioning the object through the butterfly anchor 310 and around a periphery of the rod 330, and then releasing the retractable arms.

FIG. 4A shows a side view of a device for securing and releasing an object, with the object being released from the device upon the application of pressure, in accordance with one embodiment of the present invention. In this embodiment, pressure is being applied to retractable arms of the butterfly anchor to release the object from the device.

FIG. 4B shows a side view of a device for securing and releasing an object, with the object placed on the device upon the application of pressure, in accordance with one embodiment of the present invention. In this embodiment, the object is placed on the device by applying pressure to retractable arms of the butterfly anchor, sliding the object through the retractable arms and to a location around the periphery of the rod and against an tipper peripheral edge of the butterfly anchor.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modification may be made in the embodiments chosen for illustration without departing from the spirit and scope of the invention.

What is claimed is:

1. A device for securing and releasing an object comprising:
a. a butterfly anchor having a first retractable arm and a second retractable arm, and having a nut in a middle portion of the butterfly anchor, the nut having a first nut end and a second nut end, wherein each retractable arm of the butterfly anchor is coupled to each end of the nut;
b. a spring surrounding one of the nut ends and having spring arms engaged along a portion of each retractable arm to spread them apart; and
c. a rod threaded at one end in the nut.

2. The device of claim 1 wherein the object is coupled around the periphery of the rod and resting against an upper peripheral edge of the butterfly anchor.

3. The device of claim 1 wherein the rod is coupled to a chain.

4. The device of claim 3 wherein the chain is coupled to a tool belt.

5. The device of claim 3 wherein the chain is coupled to an item of clothing.

6. The device of claim 2 wherein the object is at least one of the following: tape, electrical tape, work tools, and toilet paper rolls.

7. The device of claim 1 wherein the nut is one of a flanged nut, press-in nut, standard nut, and weld-on nut.

8. The device of claim 1 wherein the threaded rod comprises one of the following:
a screw, a bolt, a screw rod, and a shaft.

9. The device of claim 1 wherein one of the device and the rod is coupled to one of the following: a chain, a zip chain, an item of clothing, and a tool belt.

10. A method of securing and releasing an object comprising:
a. providing a butterfly anchor having a first retractable arm and a second retractable arm;
b. providing a nut in a middle portion of the butterfly anchor, the nut having a first nut end and a second nut end;
c. coupling each retractable arm of the butterfly anchor to each end of the nut;
d. surrounding one of the nut ends with a spring;
e. engaging spring arms of the spring along a portion of each retractable arm to spread them apart; and
f. threading one end of a rod in the nut.

11. The method of claim 10 further comprising coupling an object around the periphery of the rod, wherein the object rests against an upper peripheral edge of the butterfly anchor.

12. The method of claim 10 further comprising applying pressure to the retractable arms to release the object from the device.

13. The method of claim 11 further comprising applying pressure to the retractable arms to place the object on the device.

14. The method of claim 10 further comprising coupling the rod to a chain.

15. The method of claim 14 further comprising coupling the chain to a tool belt.

16. The method of claim 14 further comprising coupling the chain to an item of clothing.

17. The method of claim 11 wherein the object is at least one of the following:
tape, electrical tape, work tools, and toilet paper rolls.

18. The method of claim 10 wherein the threaded rod comprises one of the following: a screw, a bolt, a screw rod, and a shaft.

19. The method of claim 10 wherein the nut is one of a flanged nut, press-in nut, standard nut, and weld-on nut.

20. The method of claim 10 further comprising coupling one of the device and the rod to one of a chain, a zip chain, an item of clothing, and a tool belt.
